(19) United States
(12) Patent Application Publication
(10) Pub. No.: US 2010/0250274 A1
(43) Pub. Date: Sep. 30, 2010

(54) MATHEMATICAL INDEX BASED HEALTH MANAGEMENT SYSTEM

(76) Inventors: Rajesh Jugulum, Franklin, MA (US); Don Gray, Needham, MA (US); Raymond G. Cadogan, Quincy, MA (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/729,723

(22) Filed: Mar. 23, 2010

Related U.S. Application Data
(60) Provisional application No. 61/162,430, filed on Mar. 23, 2009.

(51) Int. Cl. G06Q 50/00; G06Q 10/00

(52) U.S. Cl. 705/2

(57) ABSTRACT

A process for health management of participants includes gathering data on health attributes of the participants. The Kanri index value for each of the participants is then calculated by performing Gram-Schmidt orthogonalization and Mahalanobis distance for each of the participants from a mean of the Gram-Schmidt variables. The participant is then provided with a high impact prescription from the health attributes to improve participant health.

### RELATED APPLICATIONS

This application claims priority benefit to U.S. Provisional Application 61/162,430; the contents of which is hereby incorporated by reference.

### FIELD OF THE INVENTION

The present invention relates in general to a mathematical model of participant health and in particular to an index that is proportional to participant health.

### BACKGROUND OF THE INVENTION

A large expenditure is made by health care systems in performing screening and diagnostic tests. While data indicative of certain conditions and proclivities is often present in routine data collected in the course of a well check, the ability to mine this route data systematically does not exist.

Thus, there exists a need for a mathematical index based health management system to identify influencing variables for a participant abnormality or proclivity to abnormality.

### BRIEF DESCRIPTION OF THE DRAWINGS

A process for health management of participants includes gathering data on health attributes of the participants. The Kanri index value for each of the participants is then calculated by performing Gram-Schmidt orthogonalization and Mahalanobis distance for each of the participants from a mean of the Gram-Schmidt variables. The participant is then provided with a high impact prescription from the health attributes to improve participant health.

### BRIEF DESCRIPTION OF THE DRAWINGS

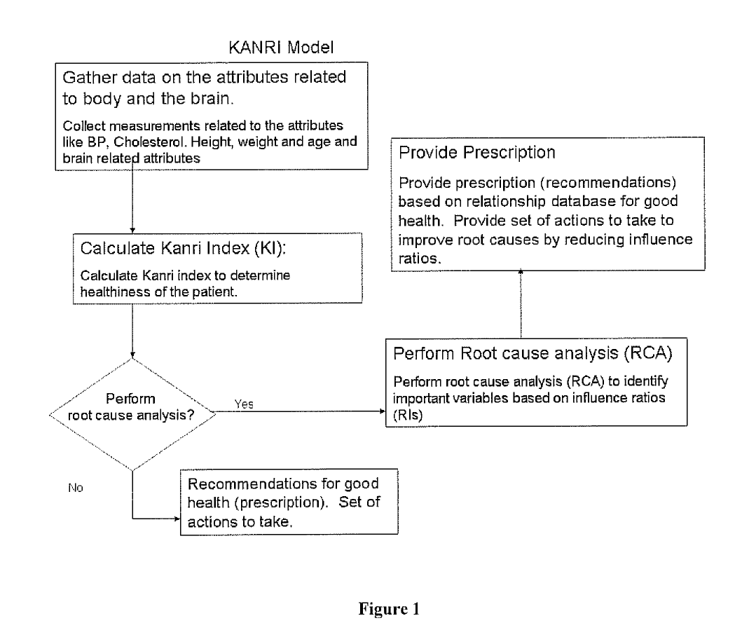

FIG. 1 is a schematic that describes the steps of the inventive Kanri health management system;

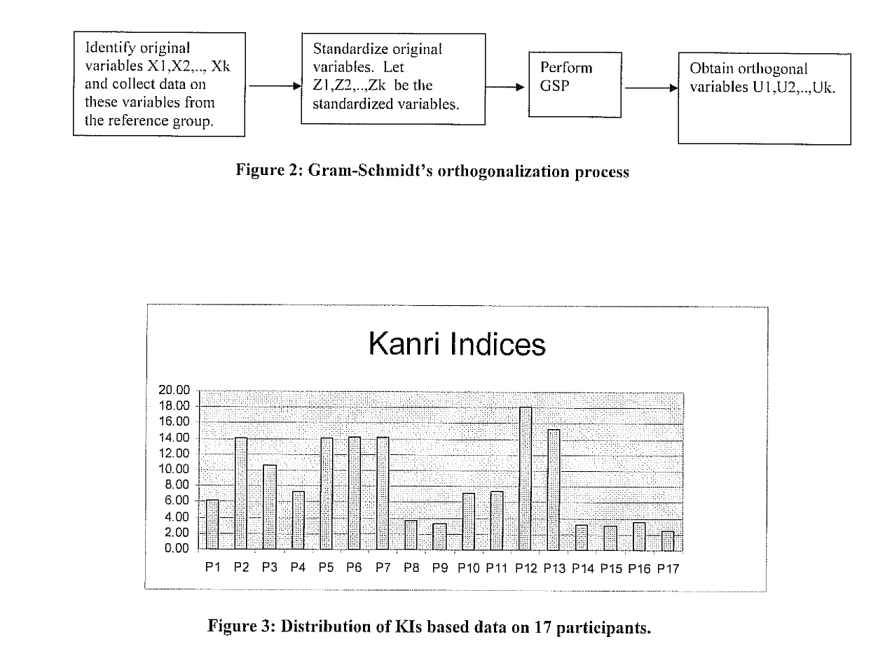

FIG. 2 is a schematic Gram-Schmidt orthogonalization process to yield orthogonal and independent variables; and

FIG. 3 is a bar graph of inventive Kanri index values for various participants.

### DETAILED DESCRIPTION OF THE INVENTION

The present invention provides a health management (monitoring, diagnosis and actions to take based on findings) system based on several attributes (variables) that are related to the body and the brain. The present invention has utility in identifying influencing variables of abnormality for an individual. These variables can then be efficiently targeted through lifestyle, therapeutics, or refined testing. Based on the information on these attributes a multivariate measurement scale is developed to determine the condition of the participant. The scale is based on the measure called Mahalanobis distance (MD). In the Kanri diagnosis model, the Mahalanobis distance is transformed into the inventive Kanri Index (KI). The lower KI indicates the higher degree of abnormality (unhealthiness) of the participant and a lower KI similarly correlates with a lower degree of health.

In the second stage of Kanri's diagnosis, a root cause analysis (RCA) is performed for the participants. In RCA, impact ratios (IRs) of the attributes for all participants are calculated. RCA allows focus on those attributes that have highest impact on a given participant. A link to relationship database is provided depending on the influencing variables for the participant. This link serves as a prescription for the participant to enable him/her to take corrective actions to reduce the impact of the variables on the overall health.

The inventive Kanri index approach helps to find the effectiveness of a prescription—if the Kanri index is higher than what was originally computed based on the attributes when the participant joined inventive Kanri program then the prescription medication or lifestyle change is effective.

In the inventive Kanri system the Mahalanobis distance (MD) is calculated and that is then transformed into Kanri index. As mentioned earlier, in the Kanri health management system a multivariate measurement scale to measure the health of a participant is constructed. A base or a reference point to this scale is required. In this case, a selected group of people with no health problems is used as a reference group. The Mahalanobis distances (and hence Kanri indices) are measured from the center of this reference group. The data corresponding to the selected variables in this group provides required information (means, standard deviations, correlation structure) to calculate the Mahalanobis distances and Kanri indices. Conventional Gram-Schmidt's orthogonalization process is used to calculate the Mahalanobis distance.

### Gram-Schmidt's Orthogonalization Process—Computation of MD

Using Gram-Schmidt's process (GSP), MDs are calculated. Preferably, Gram-Schmidt's method is used as being more accurate over other methods of obtaining MDs using inverse correlation matrix in situations where the correlation between the variables is high (multi collinearity problems) and in situations where the sample size is low.

The Gram-Schmidt's process can simply be stated as a process where original variables are converted to orthogonal and independent variables (FIG. 2). In this approach, Gram-Schmidt's process is performed on standardized variables Z1, Z2, Zk obtained from the original attributes X1, X2, Xk.

### Gram Schmidt's Orthogonalization Process

Let X1, X2, . . . , Xk be the k-variables considered for Kanri analysis. The standarized variables Z1, Z2, . . . , Zk are obtained by equation (1).

$$Zi = \frac{( Xi - {m}_{i} )}{{s}_{i}} \qquad ( 1 )$$

Xᵢ=value of i^{th} variable
mᵢ=mean of i^{th} variable in reference group
   sᵢ=standard deviation of i^{th} variable in the reference group
   k=number of variables

The means and standard deviations corresponding to the reference group are used to calculate standardized values for all participants.

If Z1, Z2, Zk are standardized variables, then the Gram-Schmidt's variables are obtained sequentially by setting:

$$\begin{matrix}U 1 = Z 1 & ( 2 a ) \\ U 2 = Z 2 - ( \frac{Z {2}^{′} U 1}{U {1}^{′} U 1} ) U 1 & ( 2 b ) \\ Uk = Zk - ( \frac{{Zk}^{′} U 1}{U {1}^{′} U 1} ) U 1 - ( \frac{Z {k}^{′} U 2}{U {2}^{′} U 2} ) U 2 - … - ( \frac{{Zk}^{′} Uk - 1}{Uk - {1}^{′} Uk - 1} ) Uk - 1. & ( 2 c )\end{matrix}$$

Where, ′ denotes transpose of a vector. Since operations are with standardized vectors, the mean of Gram-Schmidt's variables is zero.

If Sᵤ₁, Sᵤ₂, Sᵤₖ are standard deviations (s.d.s) of U₁, U2, Uk respectively then Mahalanobis distance (MD) corresponding to j^{th} observation (participant) in a sample can be obtained by equation (3).

$${MD}_{j} = ( \frac{1}{k} ) [ ( \frac{U 1 {j}^{2}}{{S}_{u 1}^{2}} ) + ( \frac{U 2 {j}^{2}}{{S}_{u 2}^{2}} ) + … + ( \frac{{Ukj}^{2}}{{S}_{uk}^{2}} ) ] \qquad ( 3 )$$

As mentioned earlier Kanri Index (KI) is obtained by transforming MD. KI corresponding to the j^{th} observation (participant) can be obtained by the equation (4).

$${KI}_{j} = ( \frac{1}{{MD}_{j}} ) \times 100 \qquad ( 4 )$$

Gram-Schmidt's coefficients and standard deviations of Gram-Schmidt's variables corresponding to the reference group are used to calculate Mahalanobis distances and Kanri indices.

In the inventive Kanri health management system, higher KI indicates better health.

The present invention is further illustrated with respect to the following nonlimiting example.

### Example

For the purpose of illustration six variables are considered as shown in Table 1.

TABLE 1
Variables considered for the inventive Kanri system

| | |
|---|---|
| X1 | Protein in Blood |
| X2 | Cholinesterase |
| X3 | Total Cholesterol |
| X4 | Triglyceride |
| X5 | Blood urea nitrogen |
| X6 | Uric acid |

Data is collected on 17 participants and is as shown in Table 2 for the variables of Table 1.

TABLE 2
Data from 17 participants based on Table 1 variables

| | | | X3 | | | |
|---|---|---|---|---|---|---|
| | X1 | X2 | Total | X4 | X5 | X6 |
| Partic- | Protein | Cholin- | Choles- | Triglyc- | Blood urea | Uric |
| ipant | in Blood | esterase | terol | eride | nitrogen | acid |
| P1 | 7.9 | 237 | 273 | 292 | 18 | 4.2 |
| P2 | 6.8 | 151 | 198 | 112 | 14 | 2.9 |
| P3 | 6.9 | 182 | 183 | 189 | 15 | 3.7 |
| P4 | 8.3 | 360 | 234 | 318 | 14 | 5.2 |
| P5 | 7.6 | 277 | 159 | 171 | 11 | 5.6 |
| P6 | 7.4 | 318 | 235 | 151 | 14 | 7 |
| P7 | 7.4 | 318 | 235 | 151 | 14 | 7 |
| P8 | 7.4 | 273 | 237 | 419 | 17 | 6.4 |
| P9 | 7 | 290 | 323 | 416 | 13 | 7.6 |
| P10 | 8.1 | 261 | 304 | 188 | 16 | 5.7 |
| P11 | 7.6 | 108 | 279 | 176 | 15 | 2.9 |
| P12 | 7.2 | 417 | 230 | 182 | 16 | 7.4 |
| P13 | 7.6 | 273 | 221 | 185 | 16 | 4 |
| P14 | 6.5 | 364 | 132 | 424 | 16 | 6.6 |
| P15 | 6.7 | 174 | 110 | 364 | 14 | 6.6 |
| P16 | 5.4 | 46 | 80 | 105 | 13 | 6.9 |
| P17 | 6.1 | 45 | 128 | 356 | 12 | 6.7 |

After applying equations (3) and (4), the MDs and KIs are obtained for these 17 participants. They are as shown in Table 3. FIG. 3 shows the distribution of KIs.

TABLE 3
Mahalanobis distances and Kanri Indices for the 17 participants

| Participant | MDs | KIs |
|---|---|---|
| P1 | 16.3 | 6.13 |
| P2 | 7.1 | 14.13 |
| P3 | 9.4 | 10.61 |
| P4 | 13.7 | 7.31 |
| P5 | 7.1 | 14.07 |
| P6 | 7.1 | 14.14 |
| P7 | 7.1 | 14.14 |
| P8 | 26.8 | 3.74 |
| P9 | 30.0 | 3.33 |
| P10 | 14.1 | 7.11 |
| P11 | 13.5 | 7.39 |
| P12 | 5.5 | 18.09 |
| P13 | 6.5 | 15.33 |
| P14 | 31.8 | 3.15 |
| P15 | 33.1 | 3.03 |
| P16 | 28.3 | 3.54 |
| P17 | 39.9 | 2.51 |

Root Cause Analysis (RCA)

Root cause analysis is performed to identify the influencing variables for abnormality of a participant. Impact of the variables associated with the abnormality can be estimated by using analysis of variance. Analysis of variance helps us to find out the contributions of variables for the overall variation (abnormality) from the reference group or healthy group. In order to perform root cause analysis, orthogonal arrays or any other fractional factorial form design of experiments matrix is used.

Role of the Fractional Factorial Designs

The purpose of using fractional factorial designs is to estimate the effects of several variables and required interactions by minimizing the number of experiments. In root cause analysis the impact ratios of the variables are determined. In fractional factorial experiments, a fraction of total number of experiments is studied. This is done to reduce cost, material and time. Main effects and selected interactions can be estimated with such experimental results. Orthogonal array is an example of this type.

Orthogonal Arrays (OAS)

Orthogonal arrays are extensively used in robust engineering applications. In robust engineering, the main role of OAs is to permit engineers to evaluate a product design with respect to robustness against noise, and cost involved by changing settings of control variables. OA is an inspection device to prevent a “poor design” from going “down stream”.

Usually, these arrays are denoted as Lₐ (b^{c}).

Where, a=the number of experimental runs;
b=the number of levels of each variable;
c=the number of columns in the array; and
L denotes Latin square design.

Arrays can have variables with many levels, although two and three level variables are most commonly encountered. L₈ (2⁷) array is shown in Table 4 as an example. This is a two level array where all the variables are varied with two levels. In this array a maximum of seven variables can be allocated. The eight combinations with 1s and 2s correspond to different variable combinations to be studied. 1s and 2s correspond to presence (on) and absence (off) of the variable. In this example there are six variables X1, X2, X6 that are allocated to the first six columns of this orthogonal array. The last column is for the responses of the eight variables combinations. In RCA, the response is the Mahalanobis distance corresponding to the variables in the respective combination. Table 4 as shown in terms of physical layout, is also shown as Table 5.

TABLE 4
L₈ (2⁷) Orthogonal Array

| | L₈(2⁷) Array | | | | | | | |
|---|---|---|---|---|---|---|---|---|
| | 1 | 2 | 3 | 4 | 5 | 6 | 7 | |
| | Variables | | | | | | | |
| Combinations | X1 | X2 | X3 | X4 | X5 | X6 | | Response |
| 1 | 1 | 1 | 1 | 1 | 1 | 1 | 1 | |
| 2 | 1 | 1 | 1 | 2 | 2 | 2 | 2 | |
| 3 | 1 | 2 | 2 | 1 | 1 | 2 | 2 | |
| 4 | 1 | 2 | 2 | 2 | 2 | 1 | 1 | |
| 5 | 2 | 1 | 2 | 1 | 2 | 1 | 2 | |
| 6 | 2 | 1 | 2 | 2 | 1 | 2 | 1 | |
| 7 | 2 | 2 | 1 | 1 | 2 | 2 | 1 | |
| 8 | 2 | 2 | 1 | 2 | 1 | 1 | 2 | |

It is to be noted that in the root cause analysis, two level arrays are preferably used to ascertain importance of the variables when it is “on” the system and when it is “off” the system.

TABLE 5
Physical layout of the corresponding to
L8 (2⁷) Orthogonal Array with 6 variables

| | L₈(2⁷) Array | | | | | | | | |
|---|---|---|---|---|---|---|---|---|---|
| | 1 | 2 | 3 | 4 | 5 | 6 | 7 | | |
| Combina- | Variables | | | | | | | | Response |
| tions | X1 | X2 | X3 | X4 | X5 | X6 | | Response | for RCA |
| 1 | On | On | On | On | On | On | | MD1 | D1 = √MD1 |
| 2 | On | On | On | Off | Off | Off | | MD2 | D1 = √MD2 |
| 3 | On | Off | Off | On | On | Off | | MD3 | D1 = √MD3 |
| 4 | On | Off | Off | Off | Off | On | | MD4 | D1 = √MD4 |
| 5 | Off | On | Off | On | Off | On | | MD5 | D1 = √MD5 |
| 6 | Off | On | Off | Off | On | Off | | MD6 | D1 = √MD6 |
| 7 | Off | Off | On | On | Off | Off | | MD7 | D1 = √MD7 |
| 8 | Off | Off | On | Off | On | On | | MD8 | D1 = √MD8 |

In table for the first combination, all the variables X1-X6 are included and compute MD for a given participant. In the second combination we use variables X1, X2 and X3 and compute MD with these three variables for the same participant. Likewise MDs for all the other combinations are computed.

As mentioned earlier, in the root cause analysis, analysis of variance to calculate impact ratios of the variables is performed. Since MD is a squared distance and analysis of variance cannot be performed on squared values, we use square root of MD (√MD) for the analysis as shown in Table 8. √MD is hereafter also denoted as D.

Computation of Impact Ratios (IRs)

Consider that an orthogonal array (or any fractional factorial experimental design) has “r” runs (variable combinations) and “k+1” columns. Let the “k” variables, X1, X2, Xk are allocated to the first “k” columns of this array as shown in Table 9.

TABLE 9
Fractional factorial design or an orthogonal array with “r”
runs and “k + 1” columns

| | Fractional (factorial design (or orthogonal array) | | | | | | | | |
|---|---|---|---|---|---|---|---|---|---|
| | 1 | 2 | 3 | . . . | . . . | k | k + 1 | | |
| Combina- | Variables | | | | | | | | Response |
| tions | X1 | X2 | X3 | . . . | . . . | Xk | | Response | for RCA |
| 1 | On | On | On | . . . | . . . | On | | MD1 | D1 |
| 2 | On | On | On | . . . | . . . | Off | | MD2 | D2 |
| 3 | On | Off | Off | . . . | . . . | Off | | MD3 | D3 |
| . | . | . | . | . . . | . . . | . | | . | . |
| . | . | . | . | . . . | . . . | . | | . | . |
| . | . | . | . | . . . | . . . | . | | . | . |
| . | . | . | . | . . . | . . . | . | | . | . |
| r | Off | Off | On | . . . | . . . | On | | MDr | Dr |

The impact ratios are calculated as follows:

$$Total Sum of Squares = TSS = {\sum }_{i = 1}^{r} ( MDi ) - \frac{{( {\sum }_{i = 1}^{r} Di )}^{2}}{r} \qquad ( 5 )$$

Where r=total number of runs

$$Sum of squares due to factor X 1 = {SS}_{X 1} = \frac{{( X {1}_{On} - X {1}_{Off} )}^{2}}{r} \qquad ( 6 )$$

Where,
X1_{On}=sum of all Ds when X1 is “On” in Table 9.
X1_{Off}=sum of all Ds when X1 is “Off” in Table 9.

r=total number of runs

$$\begin{matrix}Impact Ratio ( in \% ) of factor X 1 = {IR}_{X 1} = \frac{{SS}_{X 1}}{TSS} \times 100 & ( 7 ) \\ Sum of squares due to factor X 2 = {SS}_{X 2} = \frac{{( X {2}_{O n} - X {2}_{Off} )}^{2}}{r} & ( 8 )\end{matrix}$$

Where,
X2_{On}=sum of all Ds when X2 is “On” in Table 9.
X2_{Off}=sum of all Ds when X2 is “Off” in Table 9.
   r=total number of runs

$$Impact Ratio ( in \% ) of factor X 2 = {IR}_{X 2} = \frac{{SS}_{X 2}}{TSS} \times 100 \qquad ( 9 )$$

In general,

$$Sum of squares due to factor X i = {SS}_{Xi} = \frac{{( {Xi}_{On} - {Xi}_{Off} )}^{2}}{r} \qquad ( 10 )$$

Where,
Xi_{On}=sum of all Ds when Xi is “On” in Table 9.
Xi_{Off}=sum of all Ds when Xi is “Off” in Table 9.
   r=total number of runs

$$Impact Ratio ( in \% ) of factor Xi = {IR}_{X i} = \frac{{SS}_{X i}}{TSS} \times 100 \qquad ( 11 )$$

Equations 5-11 are calculated for all participants and so IRs for all variables are obtained for all participants.

For the example considered above, impact ratios are calculated for the 6 variables for all 17 participants. These ratios are shown in Table 10.

TABLE 10
Impact ratios corresponding to the 17 participants

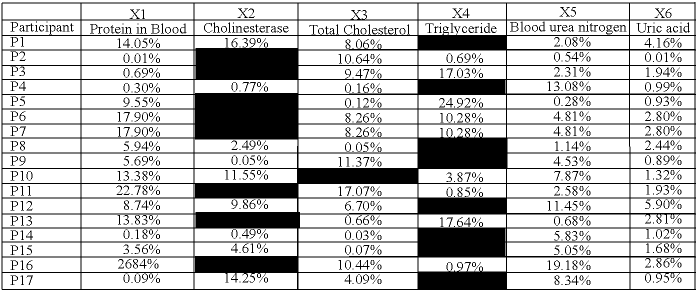

In Table 10, highlighted cells indicate highest impact ratios associated with participants.

From Table 10, X4 has highest impact ratio for participant 1, X2 has highest impact ratio for participant 2 and so on. As a result an inventive system affords a prescription for improvement will based on these high impact variables.

1. A process for health management of participants comprising:
gathering data on health attributes of the participants;
calculating the Kanri index value for each of the participants by performing Gram-Schmidt orthogonalization and Mahalanobis distance for each of the participants from a mean of the Gram-Schmidt variables; and
providing a participant with a high impact prescription from the health attributes to improve participant health.

2. The process of claim 1 further comprising performing root cause analysis on the Kanri index values to identify correlations between the health attributes to yield influence ratios.

3. The process of claim 1 or 2 wherein the calculating of the Kanri index value for each participant is done on a digital computer.

4. The process of claims 1-3 wherein at least one of the health attributes is obtained from blood chemistry analysis.

5. The process of claims 1-4 further comprising recalculating the Kanri index after a period of time to determine the effectiveness of the high impact prescription.

6. The process of claim 1 further comprising determining the mean of the Gram-Schmidt variables from a reference group of a known health status.

7. The process of claim 6 wherein the health status is normal health.

8. The process of claim 6 wherein the health status is a specific health abnormality.
